(19) United States
(12) Patent Application Publication
(10) Pub. No.: US 2011/0014320 A1
(43) Pub. Date: Jan. 20, 2011

(54) FRIED SNACK FOOD PRODUCT

(76) Inventor: Mark Zable, Plano, TX (US)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/880,755

(22) Filed: Sep. 13, 2010

Related U.S. Application Data
(60) Provisional application No. 61/367,224, filed on Jul. 23, 2010.

(51) Int. Cl. A21D 13/00; A21D 8/04

(52) U.S. Cl. 426/19; 426/560; 426/94; 426/95

(57) ABSTRACT

Disclosed is the preparation of beverage-containing snack food product. A precursor to such a product comprises a farinaceous dough material such as pretzel, pizza or pasta dough which surrounds and encases a solidified beverage material. The solidified beverage material is prepared by combining a liquid beverage such as beer with a gelling agent such as gelatin. When such a precursor is fried, a snack food product is provided which is in the form of a relatively crisp shell of fried dough surrounding a beverage which has been liquefied by the process of frying. The snack food precursor products can be frozen and stored after preparation instead of being immediately fried.

### CROSS-REFERENCE TO RELATED APPLICATION

This application claims the benefit of the filing date of U.S. Provisional Application Ser. No. 61/367,224, filed Jul. 23, 2010, under the provisions of 35 U.S.C. §119(e).

### FIELD

The present invention is directed to the preparation of a fried or fryable snack food product containing a beverage, such as in particular a beer component. When prepared in bite-sized form, such snack food products fill a special niche in the adult convenience food industry and market.

### BACKGROUND

Beer is often chosen as a beverage accompaniment to snack foods, including fried snack foods. Beer and snack foods such as potato and corn chips, pretzels, pizza, and the like are frequently consumed together and are regarded as having complimentary tastes.

Beer is also commonly used in cooking and serves as a flavoring agent for a wide variety of foods prepared therewith. For example, many cookbooks have been written which provide recipes involving the addition of beer to meat dishes, sauces, breads, pastries, batters, puddings, spreads, desserts, and the like. In such contexts, the beer which is added to and thoroughly mixed with these food dishes and ingredients loses its discrete identity as a separate identifiable liquid component and instead assumes the form and texture of the foods and/or ingredients which are being flavored with the beer.

Given the pairing which is often made of beer with snack foods, it would be desirable to be able to produce a snack food product which provides both a solid chewable bite of the snack food material along with an aliquot of a beer-flavored component in liquid form. In order to prepare a snack food product of this type, however, several difficulties need to be overcome. Snack food manufacture frequently starts with the preparation of a farinaceous dough which then needs to be cooked, e.g., fried, baked, broiled, etc., at elevated temperature, frequently in the presence of a cooking medium such as frying oil. Simple admixture of beer with snack food dough in the initial preparation stages will generally cause the dough to absorb the beer component into its structure. Subsequent heating of the beer-containing dough, e.g., by frying, further serves to eliminate any liquid components from the snack food product which has been prepared.

It has been discovered that if both snack food dough and beer components are prepared with certain types of ingredients in a certain manner and in a certain form, then a snack food product can be realized having both solid chewable and liquid beer components in discrete zones within the product. Such selected ingredient types, forms and combination steps thus give rise to the present invention as hereinafter described and claimed.

While the present development is particularly intended for use in the production of beer-containing snack food products, it is to be appreciated that the process can be practiced and the snack food products herein can be produced using other alcoholic and non-alcoholic beverages besides beer.

### SUMMARY

In one aspect, the present invention is directed to a process for preparing a fried or fryable snack product. In the first step of such a process, a raw farinaceous dough material selected from pretzel dough, pizza dough, pasta dough and bread dough is provided. In a second process step, also provided is a solidified beverage material which is formed from the combination of liquid beverage such as beer and a gelling agent.

In a next process step, a composite snack product precursor is formed by substantially encasing an aliquot of the solidified beverage material with a layer of the raw farinaceous dough material. Frying the composite snack product precursor produces a fried snack product comprising a fried crisp outer farinaceous shell substantially encasing an at least partially liquefied beverage material.

In another aspect, the present invention relates to a process for preparing a frozen beer-containing composite snack product suitable for use in a subsequent frying operation to thereby provide a fried snack product comprising a fried crisp outer farinaceous shell substantially encasing an at least partially liquefied beverage-based based material. Such a frozen product is prepared by freezing the composite snack product precursor described above. In this manner, such a frozen composite snack product precursor can then be stored until such later time as it is subsequently fried.

### BRIEF DESCRIPTION OF THE DRAWINGS

FIG. 1 of the drawings illustrates the rolling of the farinaceous dough used in the preparation of the snack food products herein.

FIG. 2 of the drawings illustrates a rectangular piece of the farinaceous dough.

FIG. 3 of the drawings illustrates placement of a solidified beverage material in the center of a square piece of the farinaceous dough.

FIG. 4 of the drawings illustrates how a square piece of farinaceous dough is to be folded around the solidified beverage material.

FIG. 5 of the drawings illustrates a square configuration of the snack food products and precursors of this invention.

### DETAILED DESCRIPTION

The snack food product of the present invention is based on a composite product formed by encasing a solidified beverage-based material such as gelled beer with a relatively thin shell layer of raw farinaceous dough and by then frying this composite to cook the dough and to also at least partially liquefy the solidified beverage material within the fried shell. Each of the several components of this composite product as well as the preparation procedures involved in producing the product are described in detail as follows.

### Farinaceous Dough

The raw farinaceous dough which is used to form the snack product herein can be any conventional dough formulation, or even pasta, which can be subsequently fried to form a crisp outer shell that forms the basic structure of the product. Farinaceous doughs of this type include doughs conventionally used for the preparation of such products as pretzels, pizza, pasta such as ravioli, or even bread. Doughs suitable for the preparation of fried products such as those of the present invention have been disclosed for example in U.S. Pat. Nos. 4,560,569; 4,738,861; 5,063,072; 5,185,167; 5,312,633; 5,925,396; and 6,277,423 and in U.S. Patent Publication Nos. 2008/0268125 and 2009/0081335. All of these U.S. patent documents are incorporated herein by reference in their entirety.

The basic ingredients of the farinaceous dough material which can be used in preparation of the snack products herein include flour, water and in many cases yeast. Salt and other flavoring agents are also commonly employed in such doughs. Typical doughs can also contain one or more type of sugar components and may also contain eggs.

Flour which can be used in the dough materials herein comprise starch-based powders made by grinding up cereal grains, other seeds, or roots. Wheat flour is commonly used and can be of several types including pastry flour, all-purpose flour, high gluten flour, fine clear flour and white whole wheat flour.

The basic dough composition is formed by adding water to the flour material and mixing the resulting combination thoroughly. Water is typically combined with flour for dough formation in amounts of from about 1 wt % to 50 wt %, more preferably from about 8 wt % to about 48 wt % or even from about 45 wt % to 48 wt %, based on the weight of the flour used.

The dough material used herein will also generally contain yeast. Yeast is a microoganism such as Saccharomyces cerevisiae which is used in dough making as a leavening agent. The yeast converts carbohydrates such as the fermentable sugars present in dough into the gas carbon dioxide. This causes the dough to expand or rise as gas forms pockets or bubbles. If used, yeast will generally be present in the dough materials used herein in amounts ranging from about 0.1 wt % to 2.2 wt %, more preferably from about 0.5 wt % to 2.0 wt %, based on the weight of the flour used.

The dough material used herein will typically contain salt and optionally other flavoring agents. Salt will generally be used to the extent of from about 0.5 wt % to 3.0 wt %, more preferably from about 1.5 wt % to 2.2 wt %, based on the weight of the flour used in the dough. Other flavoring agents can be added to the extent of up to about 3 wt % based on the weight of flour used.

Sugar can and generally will be added to the dough material used to prepare the snack products herein. Sugar, which serves as a food for the yeast and not as a contributor to the final product, can be added up to 4% of flour weight. Typical sugars employed can include dextrose, corn syrup, malt, high fructose or other fermentable sugar such as sucrose. Residual sugar contributes to the browning of the crust on the snack products herein during frying.

Eggs are another possible optional ingredient for the farinaceous dough formulations which can be used to form the snack products herein. Eggs can be added to the dough formulations herein in amounts which are typical and conventional for the preparation of egg-containing dough.

Once prepared, the dough material used herein should be kneaded and relaxed in conventional manner. The dough is then fashioned into the snack composites using the procedures described hereinafter in the section on “Composite Preparation”.

### Solidified Beverage

A second component of the composite snack product herein is a beverage material which has been solidified (i.e., congealed) by combining a liquid beverage material with a gelling agent. Beverages which can be used are, of course, generally liquid at room temperature and can include both alcoholic and non-alcoholic beverages. Suitable alcoholic beverages include beer, wine, distilled spirits and other aqueous beverages such as cocktails and highballs made from these alcoholic beverage types. Suitable non-alcoholic beverages include those potable aqueous compositions based on fruit juices and flavors, carbonated soft drinks, coffee, tea, and the like.

One suitable beverage for use in making the snack food products herein is beer. Beer is a beverage which is produced by the brewing and fermentation of starches, mainly derived from cereal grains. Most commonly, beer is made from malted barley, although wheat, maize (corn), and rice are also widely used. Most beer is flavored with hops, which add bitterness and act as a natural preservative, although other flavorings such as herbs or fruit may occasionally be used as well.

The preferred beer material used to prepare the solidified beverage component of the snack products herein will generally range in alcohol content from about 3% to 11% by volume and will have a non-volatile dissolved solids content of from about 2% to 12% by weight. Many different styles and types of beer may be used including pilsners, lagers, ales, stouts, porters, malt liquors, krieks and lambics.

The beverage material which is incorporated into the snack food products herein will be solidified by combining the liquid beverage material with a suitable food-grade gelling agent. Typical gelling agents include natural gums such as carrageenan, polysaccharides such as alginates, pectins, agar-agar, and gelatin. The preferred gelling agents for use herein are pectin and gelatin. Gelatin, which is made by partial hydrolysis of animal collagen, is the most preferred.

The liquid beverage material is combined with the gelling agent in relative amounts of each component and using procedures and under conditions which will produce a solidified beverage material. For purposes of the present invention, a solidified beverage material is one wherein the mass of beverage material, unconstrained by any container, maintains at least some three-dimensional structural integrity at room temperature (68° F.) for a period of at least 24 hours. Such solidified beverage material may be elastically, semi-elastically or inelastically deformable by application of force thereto so long as some three-dimensional structural integrity of the mass of beverage material remains after application of such force is withdrawn.

It may be necessary to utilize selected procedures and conditions when combining the liquid beverage material with the gelling agent in order to realize the requisite solidified beverage material from the beverage/gelling agent combination. For example, it may be necessary to form a premix of gelling agent dissolved or dispersed in a portion of the beverage to be solidified before adding that premix to the balance of the liquid beverage material. It may also be necessary to heat the beverage/gelling agent combination, for example to a temperature from above room temperature e.g., about 70° F., to at or just below boiling, e.g., about 200° F., more preferably from about 160° F. to 200° F., to achieve complete dissolution or dispersion of the gelling agent in the beverage liquid. Once the gelling agent and beverage liquid are combined, it may also be necessary to then chill that combination, for example to a temperature from just above freezing, e.g., about 30° F., to just below room temperature, e.g., about 50° F., more preferably from about 30° F. to 35° F., in order to have the beverage liquid/gelling agent combination set to a suitable solidified beverage material.

In a typical embodiment using beer as the liquid beverage and gelatin as the gelling agent, from about 3 to 10 tablespoons of gelatin per gallon of beer can be used. More preferably, from about 4 to 8 tablespoons of gelatin per gallon of beer are employed.

### Composite Preparation

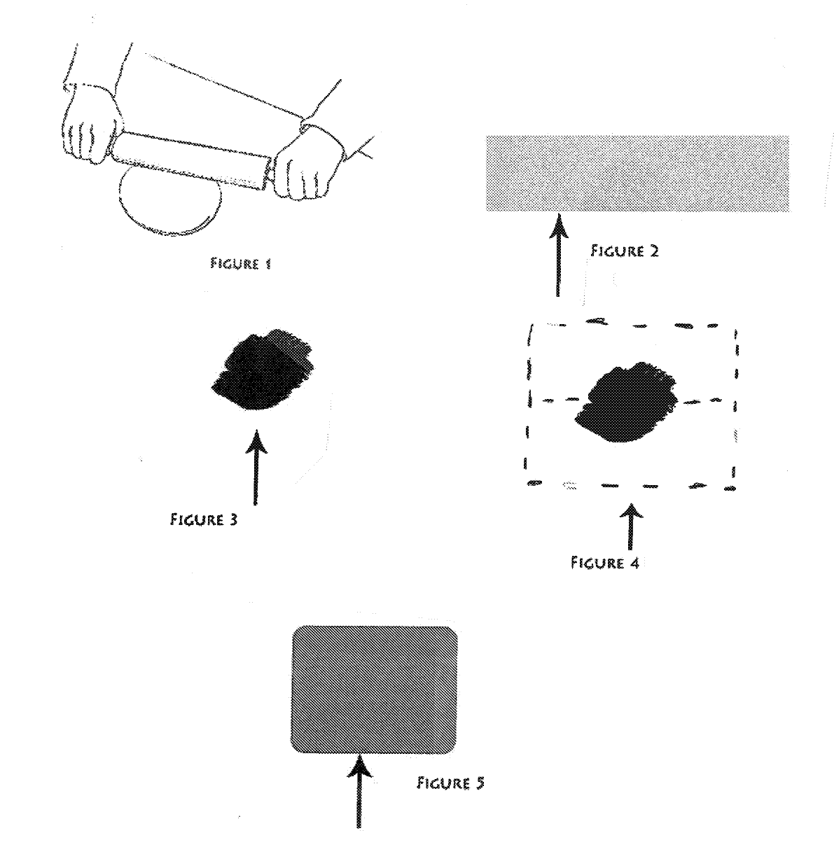

After the farinaceous dough has been kneaded and relaxed in conventional manner, the dough is rolled or extruded into continuous sheets. This can be done either mechanically by hand as shown in FIG. 1 or can be done by extrusion of the dough through a nozzle in connection with a continuous manufacturing, e.g., commercial, operation. The continuous sheets of dough will typically range in thickness from about 5 to 25 mm, more preferably from about 5 to 10 mm.

The sheets of dough are then cut or otherwise fashioned into pieces of any desired shape or size that can be used for making snack food composites suitable for subsequent marketing or eating. Typically, such pieces of the dough can be circular, polygonal, elliptical, triangular, rectangular such as shown in FIG. 2 of the drawings, square, trapezoidal, star-shaped, irregular, etc. and will be of a size suitable for forming snack- or bite-size composites. Such dough pieces will preferably weigh from about 0.5 to 4.0 ounces. Four inch square pieces are ideal.

Aliquots of the solidified beverage material are then combined with the dough pieces. Such aliquots will typically range from about 0.25 to 3.0 ounces in weight. The weight ratio of the raw dough material in the dough pieces to the solidified beverage material in the aliquot will typically range from about 1:1 to 1:5, more preferably from about 1:1 to 1:3. The aliquot of solidified beverage material can be placed at the center of a four-inch square piece of dough as shown in FIG. 3 of the drawings.

The combinations of the raw dough pieces and the aliquots of solidified beverage material are then worked so as to form composite snack food product precursors each having the aliquot of solidified beverage material substantially completely encased by a layer of the raw farinaceous dough material. This can be done by folding the pieces of dough material over the beverage material aliquot along the dotted lines as shown in FIG. 4 of the drawings. The dough is then pressed together at the edges of the folded-over sections to form the composite pieces as shown in FIG. 5 of the drawings.

Alternatively, the composite snack food precursor pieces can be formed continuously by, for example, forming a continuous strip or sheet of dough material, and depositing a continuous filling of the solidified beverage material onto the dough strip or sheet or in pockets formed therein. Another layer of dough can then be placed over the dough with the beverage material thereon, and the resulting multilayer dough structure can then be cut into pieces of appropriate size and configuration. Automated food processing equipment such as a commercial ravioli maker can also be used to form the snack food precursor pieces herein.

The composite snack food precursor pieces can be made in “bite-size” form such that, prior to frying, each piece weighs 8 ounces or less. Alternatively, of course, the composite snack food precursor pieces, prior to frying, can weigh more than 8 ounces if desired.

### Frying

The composite snack food precursor pieces formed as hereinbefore described can be converted into edible snack food products by frying such precursor pieces. Frying produces a relatively crisp outer shell which substantially encases the beverage material in the pieces. (For purposes herein, the outer shell is “relatively crisp” if the frying operation has rendered the shell to at least some extent harder than the raw dough material surrounding the precursor piece prior to frying.) Frying not only cooks the raw dough layer surrounding the solidified beverage material of the precursor pieces, the heat of the frying operation also serves to at least partially liquefy, and preferably to completely liquefy, the solidified beverage material inside the fried product.

Frying of the precursor pieces herein can generally be carried out at a temperature of from about 350° F. to 400° F. for a period of time sufficient to form a fried relatively crisp outer farinaceous shell from said raw dough material and to at least partially liquefy the solidified beverage material encased by the fried dough shell. Typical frying times can generally range from about 10 to 180 seconds, more preferably from about 10 to 60 seconds. For frying operations, the precursor pieces can be contacted with a frying medium such as vegetable or other frying oil. For deep frying, the precursor pieces can be completely immersed in the frying oil.

### Freezing

After preparation of the composite snack food precursor products described above, these precursor pieces need not be fried right away. Such pieces may instead be frozen to preserve them for frying at a later time. Precursor pieces frozen for storage can themselves be a marketable item of commerce.

### Example

Preparation of a fried snack food product in accordance with the present invention is illustrated by the following example:

### Pretzel Dough Preparation

A pretzel dough is made from a mixture of high quality bread flour, water, yeast, salt and sugar. Water is added to the extent of from about 45%-48% of the flour weight. Salt content of the dough is 1.5% to 2.2% of the flour weight. Yeast is added in an amount of 0.5% to 2% of the flour weight. Up to 4% of the flour weight of sugar, e.g., dextrose, is added to the dough as a food for the yeast.

The pretzel dough is kneaded and is relaxed and formed by rolling into a continuous flat sheet of dough approximately one-half inch thick and 4 inches wide. The rolled dough is then cut into 4 to 6 inch squares.

### Solidified Beer Preparation

One gallon of Miller Genuine Draft lager beer is chilled to a temperature of about 32° F. The beer is removed from refrigeration, and 2 to 4 ounces of it are placed in a standard food bowl. Gelatin in an amount of about 4 to 8 tablespoons is sprinkled onto the cold liquid in the bowl, and the contents of the bowl are allowed to stand for 2 to 4 minutes. The remaining beer is heated until it just begins to boil. The beer is removed from the heat and is combined with the cold beer/gelatin mixture until that mixture is dissolved. The beer is then placed in refrigeration at 32° F. until it is set firm. The beer is removed from refrigeration when firm and cut into small pieces of solidified beer of about 1 ounce each.

### Fried Snack Preparation

A spoonful of a 1 to 3 ounce aliquot of the solidified (congealed) beer is placed in the center of each of several of the square pieces of the rolled dough. Each dough piece is then folded over the aliquot of solidified beer and is then pressed on all sides to ensure that the solidified beer is tightly sealed on the inside of the dough. The beer-filled dough pieces are then placed in a deep fryer and can be fried for 2 to 3 minutes, although more preferably from about 10 to 60 seconds, in frying oil at about 350° F. The pieces are removed when brown on both sides and salted prior to serving. When cool enough to eat, the fried snack food pieces contain liquid beer when bitten into.

What is claimed is:

1. A process for preparing a precursor of a beverage-containing snack product, which process comprises:
A) providing raw farinaceous dough material selected from pretzel dough, pizza dough, bread dough and pasta dough;
B) providing a solidified beverage material formed from the combination of liquid beverage and a gelling agent; and
C) forming a composite snack product precursor by substantially encasing an aliquot of said solidified beverage-based material with a layer of said raw farinaceous dough material.

2. A process according to claim 1 further comprising the step of:
D) frying said snack product precursor to produce a fried snack product comprising a fried relatively crisp outer farinaceous shell substantially encasing an at least partially liquefied beverage material.

3. A process according to claim 1 wherein said raw farinaceous dough material comprises flour, water, salt, and optionally yeast, sugar and/or eggs and wherein the gelling agent combined with said liquid beverage is selected from gelatin and pectin.

4. A process according to claim 3 wherein the water content of said raw farinaceous dough comprises from about 1 wt % to 50 wt % of the flour weight.

5. A process according to claim 3 wherein the salt content of said raw farinaceous dough comprises from about 1.5 wt % to 2.2 wt % of the flour weight.

6. A process according to claim 3 wherein said raw farinaceous dough contains yeast in an amount of from about 0.1 wt % to 2.2 wt % of the flour weight.

7. A process according to claim 3 wherein said raw farinaceous dough comprises sugar in an amount of up to about 4.0 wt % of the flour weight.

8. A process according to claim 7 wherein said sugar is selected from the group consisting of dextrose, corn syrup, malt, high fructose and sucrose.

9. A process according to claim 3 wherein the gelling agent is gelatin and is combined with said liquid beverage in an amount of from about 3 to 10 tablespoons of gelatin per gallon of the beverage.

10. A process according to claim 9 wherein said gelatin is combined with from about 2 to 4 ounces of the liquid beverage to form a premix which is chilled to a temperature of from about 30° F. to 35° F. and held for a period of from about 2 to 4 minutes before said premix is dissolved in additional liquid beverage at the requisite concentration.

11. A process according to claim 10 wherein said additional liquid beverage is heated to a temperature of from about 160° F. to 200° F. to facilitate dissolving of said premix therein.

12. A process according to claim 11 wherein said additional liquid beverage with said premix dissolved therein is chilled at a temperature of from about 30° F. to 35° F. for a period of time sufficient to form said solidified beverage material.

13. A process according to claim 1 wherein said aliquot of solidified beverage material comprises from about 0.25 to 3.0 ounces and is substantially encased in a layer of raw dough material which ranges from about 5 to 25 mm in thickness, in order to form said composite snack product precursor.

14. A process according to claim 13 wherein the weight ratio of raw dough material to solidified beverage material ranges from about 1:1 to 1:3.

15. A process according to claim 1 wherein said beverage material used in the process comprises beer.

16. A process according to claim 2 wherein said composite snack product precursor is fried at a temperature of from about 350° F. to 400° F. for a period of time sufficient to form a fried relatively crisp outer farinaceous shell from said raw dough material and to at least partially liquefy said solidified beverage material encased by said shell.

17. A process according to claim 16 wherein said composite snack product precursor is deep fried by contact of said composite snack product precursor with frying oil.

18. A process according to claim 2 wherein said composite snack product precursor is frozen before being fried.

19. A process for preparing a frozen beverage-containing composite snack product suitable for subsequent frying, which process comprises:
A) providing raw farinaceous dough material selected from pretzel dough, pizza dough and bread dough;
B) providing a solidified beverage material formed from the combination of liquid beverage and a gelling agent;
C) forming a composite snack product precursor by substantially encasing an aliquot of said solidified beverage material with a layer of said raw farinaceous dough material; and thereafter
D) freezing said composite snack product precursor for a desired period of storage time until such frozen composite snack product precursor can be fried to produce a fried snack product comprising a fried crisp outer farinaceous shell substantially encasing an at least partially liquefied beverage material.

20. A precursor to a composite snack product comprising an outer shell of a raw farinaceous dough material surrounding an inner core of a solidified beverage material formed from the combination of liquid beverage and a gelling agent.

21. A composite snack product precursor according to claim 20 which weighs 8 ounces or less.

22. A composite snack product precursor according to claim 20 which weighs more than 8 ounces.

23. A composite snack product precursor according to claim 20 which is frozen.

24. A fried composite snack product comprising an outer shell of fried farinaceous dough material surrounding an inner core of an at least partially liquefied beverage material formed during frying from a solidified beverage material comprising the combination of liquid beverage and a gelling agent.
